(19) United States
(12) Patent Application Publication
(10) Pub. No.: US 2012/0251775 A1
(43) Pub. Date: Oct. 4, 2012

(54) Recording Material for Electrophotographic Printing Process

(75) Inventors: Rainer Steinbeck, Osnabruck (DE); Christoph Kozlowski, Osnabruck (DE); Andreas Overberg, Osnabruck (DE)

(73) Assignee: Schoeller Technocell GmbH & Co. KG, Osnabruck (DE)

(21) Appl. No.: 13/434,113

(22) Filed: Mar. 29, 2012

(30) Foreign Application Priority Data
Mar. 30, 2011 (EP) 11160422.9

(51) Int. Cl. B32B 15/08; B32B 15/082; B32B 5/16; B32B 3/00

(52) U.S. Cl. 428/141; 428/457; 428/463; 428/329; 428/328; 428/331; 428/461

(57) ABSTRACT

The invention relates to a recording material for electrophotographic printing processes, that comprises a carrier material, a metal coated plastic film and a toner-absorbing layer, and which is suitable for producing images of near-photographic quality using both dry and liquid toners.

### FIELD OF THE INVENTION

The invention relates to a recording material with which images may be produced in photographic quality with electrophotographic printing processes.

### BACKGROUND OF THE INVENTION

The laser printer is based on the principle of electrophotography. In electrophotography, a latent image is generated from electrical charges by irradiating or exposing a photo-conductor with the optical copy of an image, and this image is subsequently used to apply a toner selectively (development) and generate a reproduction (copy) of the image on paper, for example. A distinction is made between direct and indirect, and also wet and dry electrophotography. The wet processes, also called liquid toner processes, use a suspension of an aliphatic solvent with a low dielectric constant and the toner as the developer, whereas the dry process employs a powder. A copy of the desired page is marked on the light-sensitive drum using a concentrated laser beam and a rotating mirror. The drum is negatively charged initially, but the charge is neutralised at the points where the laser beam exposes the photoconductor surface. The shape of the surface areas from which the charge has been removed corresponds to the subsequent printed output. The toner is applied to the drum via a roller with negatively charged toner, which sticks to the sites on the drum that do not carry a charge.

In the dry process, the paper is then passed over the drum. It merely slides past the drum. A potential field is formed behind the paper. The toner is transferred to the paper, where it is initially loose. Then, the toner is fixed using a hot roller and pressure. The charge is drained from the drum and excess toner is removed from it.

In the liquid toner process the toner suspension is first transferred to a heated rubber cylinder, on which the carrier liquid is evaporated and the toner is plasticised. From this intermediate drum, the toner image is then transferred to the image receiving sheet.

The images created using a laser printer should attain a quality comparable with a photograph. Properties to be considered for this purpose include gloss, stiffness, opacity, high resolution and image definition, and good resistance to light.

The publication by HP (Hannelore Breuer): Das Know-how des Druckens: Die neuen Laser-Papiere (English: Expertise in printing: The new laser papers) dated May 13, 2005, available under 41131.www4.hp.com/Backgrounder_Neue_Laser-Papiere.pdf (last updated on Aug. 31, 2010) describes papers with multilayer coatings and an “open” porous surface on both sides. However, the texture of images reproduced using these papers differ considerably from conventional silver halide images and their gloss and surface are also quite dissimilar.

In order to get closer to the objective of near-photographic quality, electrophotographically created images are produced on carrier materials that have the same haptic properties and appearance as a typical silver salt photograph. An image receiving material for electophotography that comprises a base paper coated with a thermoplastic resin, a toner receiving layer and an antistatic rear side layer is described in document DE 44 35 350 C1. The disadvantage of this material is that it is still not ideal with regard to toner fixing and its behaviour in the printer. Moreover, after an image has been printed such materials exhibit shiny patches, originating from the oily substances frequently used as releasing agents in the toner formulas.

Other recording materials for electrophotographic processes are described for example in EP 0 789 281 B1, EP 1 115 559, JP 2006-215 494, JP 2007-188 055 and JP 2010-020 283.

### SUMMARY OF THE INVENTION

It is therefore the object of the invention to provide a recording material that is printable from at least one side, has good image quality, comparable with that of a silver salt photograph, and besides being resistant to light and ozone during storage also has good pickup and transport behaviour in the printer and lends itself well to stacking.

This object is solved with a recording material having a carrier material and at least one toner-absorbing layer, wherein the recording material includes a plastic film that is coated with a metal and positioned between the carrier material and the toner-absorbing layer.

The metals used for coating the plastic film are preferably metals with an electric conductivity of not more than 40×10⁶ S/m. Electrical conductivity describes the capability of a substance to conduct electric current, the reciprocal value of which is specific resistance. Aluminium is particularly well suited for this purpose.

The plastic film suitable for coating with the metal may be a polyolefin film, for example a polyethylene or polypropylene film. It may have a monolayer or multilayer structure. Preferably, a multilayer, biaxially oriented polyolefin film particularly a polypropylene film is used. The polyolefin film preferably includes a porous core layer and at least one essentially non-porous surface layer disposed on at least one side of the core layer.

The metal-coated plastic film may preferably have a thickness from 10 to 50 μm. The metal-coated plastic film preferably has an opacity greater than 98% and a specific surface topography, expressed by a roughness value Rz from 0.01 to 2 μm.

The carrier material may be an uncoated base paper, a coated base paper (base paper provided with a pigment-containing layer) or a resin-coated paper.

The toner-absorbing layer may preferably contain a binder that is soluble and/or dispersible in water, a finely particulate, oil absorbing pigment and/or an electrically conductive component, wherein the electrically conductive component may be a finely particulate electrically conductive oxide or an electrically conductive polymer.

### DETAILED DESCRIPTION OF THE INVENTION

For the purposes of the invention, the term base paper is used to refer to an uncoated or surface-sized paper. Besides cellulose fibres, a base paper may contain sizing substances such as alkyl ketene dimmers, fatty acids and/or fatty acid salts, epoxidised fatty acid amides, alkenyl or alkyl succinic acid anhydride, wet strengthening agents such as polyamine-polyamide-epichlorhydrin, dry strengthening agents such as anionic, cationic or amphoteric polyamides or cationic starches, optical brighteners, bulking agents, pigments, dyes, antifoaming agents, and other auxiliary substances known in the paper industry. The base paper may be surface sized. Sizing substances suitable for this purpose include for example polyvinyl alcohol or oxidised starch. The base paper may be produced on a Fourdrinier or a Yankee paper machine (cylinder paper machine). The grammage of the base paper may be from 50 to 250 g/m², particularly from 80 to 180 g/m². The base paper may be used in uncompacted or compacted form (finished). Base papers having a density from 0.8 to 1.2 g/cm³, particularly 0.90 to 1.1 g/cm³, are particularly suitable. Cellulose fibres may be obtained for example from laubholz bleached kraft pulp (LBKP), northern bleached kraft pulp (NBKP), laubholz bleached sulphite pulp (LBSP) or northern bleached sulphite pulp (NBSP). Cellulose fibres recovered from paper waste may also be used. The cellulose fibres listed in the preceding may also be used together in mixtures and fractions of other fibres, resin fibres for example, may be added to the mixture. However, cellulose fibres from 100% laubholz cellulose are preferred. The average fibre length of the unrefined cellulose is preferably 0.6 to 0.85 mm (Kajaani measurement). The cellulose also has a lignin content of less than 0.05% by weight, particularly from 0.01 to 0.03% by weight, relative to the mass of the cellulose.

Bulking agents used in the base paper may include for example kaolin, calcium carbonate in its natural forms, such as lime-stone, marble or dolomite stone, precipitated calcium carbonate, calcium sulphate, barium sulphate, titanium dioxide, talcum, silica, aluminium oxide and mixtures thereof. Calcium carbonate having a grain size distribution in which at least 60% of the particles are smaller than 2 μm and not more than 40% are smaller than 1 μm is particularly suitable. In a particular embodiment of the invention, calcite with a grain size distribution in which about 25% of the grains have a grain size smaller than 1 μm and about 85% of the particles have particle size less than 2 μm.

In a particular embodiment of the invention, a pigment-containing layer may be applied to the base paper. The pigment may be a metal oxide, silicate, carbonate, sulphide or sulphate. Pigments such as kaolin, talcum, calcium carbonate and/or barium sulphate are particularly suitable. Particularly preferred is a pigment with a narrow grain size distribution in which at least 70% of the pigment particles are smaller than 1 μm. The fraction of the pigment with such narrow grain size distribution as part of the total pigment quantity is at least 5% by weight, particularly 10 to 90% by weight. Particularly good results may be obtained if the amount of pigment having the narrow grain size distribution accounts for 30 to 80% by weight of the total pigment quantity. According to the invention, pigments with a narrow grain size distribution are also understood to include pigments with a grain size distribution in which at least about 70% by weight of the pigment particles are smaller than about 1 μm and the difference between the pigment with the largest grain size (diameter) and the pigment with the smallest grain size is less than about 0.4 μm in 40 to 80% by weight of these pigment particles. A calcium carbonate with a d50% value of about 0.7 μm proved particularly advantageous.

In a further embodiment of the invention the pigment-containing layer may contain a pigment mixture that is constituted of the calcium carbonate and kaolin referred to in the preceding. The calcium carbonate/kaolin ratio is preferably 30:70 to 70:30. The binding agent/pigment ratio in the pigment containing layer may be from 0.1 to 2.5, preferably 0.2 to 1.5, but particularly about 0.9 to 1.3. Any known binding agent that is soluble and/or dispersible in water may be used in the pigment containing layer. Besides latex binders, binding agents that are particularly suitable for this include film-forming starches such as thermally modified starches, particularly corn starches or hydroxypropylated starches. The pigment-containing layer may be applied inline or offline using any standard application units in the paper manufacturing industry, and the application quantity is selected such that after drying the coating weight is 0.1 to 30 g/m², particularly 1 to 20 g/m², or according to a particularly preferred embodiment 2 to 8 g/m². In a preferred embodiment, the pigment-containing layer is applied using a size press or film press that is integrated inside the paper machine.

In another embodiment of the invention, layers of resin may be provided on both sides of the base paper or coated base paper. The resin layers (front and/or rear resin layer) may preferably contain a thermoplastic polymer. Particularly suitable for this are polyolefins, for example low density polyethylene (LDPE), high density polyethylene (HDPE), poly-propylene, 4-methylpentene-1 and mixtures thereof, also poly-esters, for example polycarbonates. In a particular refinement of the invention the thermoplastic polymer is a biodegradeble polymer and/or a polymer based on renewable raw materials such as a linear polyester, thermoplastically modified starch, or polylactic acid or a mixture of these polymers with each other or with other polymers.

In a further particularly preferred refinement of the invention the resin layer on front and/or rear side contains at least 40% by weight, particularly 60 to 80% by weight HDPE with a density greater than 0.95 g/cm³. A particularly preferred composition consists of 65% by weight HDPE with a density greater than 0.95 g/cm³, and 35% by weight LDPE with a density lower than 0.935 g/cm³.

The resin layers may contain white pigments such as titanium dioxide and additional auxiliary agents such as optical brighteners, dyes and dispersing agents. In a particular embodiment of the invention, antistatic substances, particularly electrically conductive inorganic pigments, are added to the resin layers.

The coating weight of the resin layers may be 5 to 50 g/m², particularly 5 to 30 g/m², but preferably 10 to 20 g/m². The resin layer may be extruded or co-extruded in multiple layers onto the base paper or coated base paper. Extrusion coating may be carried out at machine speed up to 600 m/min.

In one embodiment of the invention, the resin layers may be applied symmetrically to both sides of the base paper, that is to say the resin layers on both sides of the base paper have the same composition and are identical with regard to surface topography. According to the invention, the surface of the resin layer on both sides may have roughness values Rz from 0.03 to 15 μm. Roughness Rz is determined in accordance with DIN 4768 using a Hommel surface scanner.

In a further embodiment of the invention, the objective of which is to produce a glossy recording material that is printable on one side, the resin layer on the side of the recording material that supports the toner-absorbing layer and that is intended to receive the printing (front side) is less rough than the resin layer on the rear side. In this embodiment, the resin layer on the side intended to receive the printing has roughness values Rz from 0.03 to 1.8 μm, whereas the resin layer on the side that is not intended for printing has roughness values Rz from 12 to 16 μm.

According to the invention, a metal-coated plastic film is first applied by lamination to the side of the carrier material, particularly a base paper or coated base paper, that is intended for printing. In this context, a polymer layer, preferably low density polyethylene (LDPE), is extruded between the carrier material and the plastic film. The thickness of the polyethylene layer is 6 to 15 g/m², particularly 6 to 10 g/m².

According to the invention, the metal-coated plastic film may be laminated onto one or both sides of the carrier material. In the embodiment of the invention according to which the metal coated plastic film is only positioned on one side of the carrier material, the rear side of the carrier material may be coated within an extruded thermoplastic polymer. Particularly suitable for this are polyolefins, for example low density polyethylene (LDPE), high density polyethylene (HDPE), polypropylene, 4-methylpentene-1 and mixtures thereof, also polyesters. The coating weight of the polymer layer on the rear side may be 5 to 50 g/m², particularly 5 to 30 g/m². In a further embodiment of the invention a monolayer or multilayer plastic film, particularly a biaxially oriented polypropylene film may be applied to the rear side. The core layer may be covered on either side by essentially non-porous surface layers.

In the next step, a toner-absorbing coating solution is coated onto the metal-coated side of the film that is applied to the carrier material, and after drying this forms the toner-absorbing layer. In the particular version of the invention that is designed to produce a recording material that is printable on both sides, the metal-coated plastic film and the toner-absorbing layer applied to both sides of the carrier material.

The toner-absorbing layer preferably contains at least one binder that is soluble and/or dispersible in water, a finely particulate pigment and/or an electrically conductive component.

The binder in the toner-absorbing layer may be any binder in standard use for paper coatings, the preferred binder substances being starch, polyvinyl alcohol, acrylates or copolymers of acrylates with other monomers. Particularly preferred binders are ethylene acrylic acid copolymers, particularly those that with a melting point between 70 and 100° C.

According to the invention, the finely particulate pigment in the toner absorbing layer is a finely particulate inorganic pigment, for example silicon dioxide, aluminium oxide, aluminium oxide hydrate, aluminium silicate, calcium carbonate, zinc oxide, tin oxide, antimony oxide, titanium dioxide, indium oxide or a mixture of these oxides. In a particularly preferred embodiment, the finely particulate pigment is zinc oxide, tin oxide, antimony oxide, titanium dioxide, indium oxide or mixture of these oxides. The finely particulate pigments may be present in the toner-absorbing layer alone or as mixtures.

The finely particulate pigments in the toner-absorbing layer preferably have an average particle size smaller than 1000 nm, particularly smaller than 200 nm. Pigments with a BET surface area from 30 m²/g to 400 m²/g are particularly preferred. Pigments according to the invention may be obtained by the flame method or by wet chemical precipitation processes.

According to the invention, the electically conductive component in the toner-absorbing layer may be an electrically conductive polymer and/or an electrically conductive pigment. Electrically conductive polymers according to the invention may be such in which the electrical charge is transported in the form of ions, such as polystyrene sulphuric acid. However preference is given to polymers, in which the electrical charge is transported in the form of electrons or electron holes, for example polyanilines and polythiophenes. A substance that is particularly preferred as a conductive polymer is poly(3,4-ethylene-dioxythiophene) doped with polystyrene acid (PEDOT:PSS), and which is available commercially under the names CLEVIOS® or ORGACON® for example. If a polymer is used as the electrically conductive component in the toner-absorbing layer in accordance with the invention, in a particular variation of the invention it may replace some or all of the water-soluble or water-dispersible binder.

Conductive pigments according to the invention may be made up of metal powder or carbon, among other components. However, oxides such as antimony oxide, tin oxide, indium oxide, or particularly preferably titanium dioxide or zinc oxide, of oxide mixtures of the elements antimony, indium, titanium, zinc or tin are preferred. The conductive pigments according to the invention preferably have an average particle size smaller than 1000 nm, particularly preferably smaller than 200 nm. If a conductive pigment is used as an electrically conductive component, in a preferred embodiment of the invention it may also be the finely particulate pigment of the toner-absorbing layer.

The quantity of the electrically conductive component in the toner-absorbing layer is selected such that the surface resistivity of the recording material is less than 15 log (Ohm/cm), measured according to DIN 53483. According to the invention, it may lie in a range from 0 to 50% by weight, particularly 0.1 to 4.0% by weight, relative to the mass of the dry layer.

In a further variation of the invention, the toner-absorbing layer also contains anionic or non-ionic surfactants in a quantity of 0.01 to 4.0% by weight, particularly 0.05 to 2.5% by weight relative to the dried layer.

The toner-absorbing layer may contain other auxiliary agents if necessary, for example matting agents, dyes, crosslinking agents, lubricants, anti-blocking agents and other usual additives.

The coating compound for forming the toner-absorbing layer may be applied inline or offline using any of the application equipment commonly used in such processes, wherein the quantity is selected such that the coating weight after drying does not exceed 3 g/m², particularly 0.1 to 2 g/m², or according to a particularly preferred embodiment, 0.3 to 0.7 g/m². The coating compound may be spread on with the aid of a standard coating mechanism integrated in the extrusion coating system. A 3-roller application is particularly suitable for this purpose, or a squeegee device.

In a further embodiment of the invention, further layers such as protective layers or gloss enhancing layers may be applied over the toner absorbing layer. The coating weight of such layers is preferably less than 1 g/m².

The invention will be explained in greater detail with reference to the following examples.

### EXAMPLES

A base paper A was produced from eucalyptus pulp. For refining, the pulp was placed in a roughly 5% aqueous suspension (thick matter) and ground to a degree of fineness corresponding to 36° SR with the aid of a refiner. The average fibre length was 0.64 mm. The concentration of cellulose fibres in the thin matter was 1% by weight relative to the mass of the cellulose suspension. Additives were added to the thin matter, including cationic starch in a quantity of 0.4% by weight, alkyl ketene dimer (AKD) as a neutral sizing agent in a quantity of 0.48% by weight, wet strengthening agent polyamine-polyamide-epichlorhydrin resin (Kymene®) in a quantity of 0.36% by weight, and a natural CaCO₃ in a quantity of 10% by weight. The quantities indicated are relative to the cellulose mass. The thin matter, the pH value of which was adjusted to about 7.5, was transported from the headbox to the screen on the paper machine, after which the machine began to form sheets by dewatering the web in the screen area of the paper machine. In the compaction area, the web was dewatered further to reach a water content of 60% by weight relative to the weight of the web. Further drying took place in the drying area of the paper machine with heated drying cylinders. A base paper having a grammage of 160 g/m² and moisture of about 7% was obtained.

The base paper is coated on both sides with a coating compound consisting of a styrene acrylate binder, starch and a pigment mixture of calcium carbonate and kaolin, each having a coating weight of 15 g/m², it is then dried and finished with a calender. The material obtained in this way is referred to in the following as base paper A, which will be placed in the extruder for the subsequent lamination of the metal coated film.

Base paper B was produced from eucalyptus pulp in the same way as base paper A. However, in the pulp dispersion it also contains titanium dioxide in such an amount that the base paper web still contains 10% by weight TiO₂ relative to the dry mass after production. This base paper B was placed directly into an extruder for subsequent lamination of the metal-coated film without applying any additional coating compound.

Both surfaces (front sides) of base papers A and B that were intended to receive printing underwent irradiation with corona discharge and then laminated in the laminator with a metallised, multilayer, biaxially oriented polypropylene film (BOPP-Film, PZN, Vibac GmbH), wherein a film of low density polyethylene (LDPE) was extruded between the paper carrier material and the plastic film. The thickness of the adhesive polyethylene film was 8 g/m². The opposite side to the printable side (rear side) of base papers A and B was coated in the extruder with a polyethylene mixture of 30% by weight of a low density polyethylene (LDPE, d=0.923 g/cm³) and 70% by weight of a high density polyethylene (HDPE, d=0.964 g/cm³), having a coating weight of 40 g/m². The cooling cylinder was selected such that the resulting surface of the rear side has a roughness of 0.9 μm measured as an Rz value in accordance with DIN 4768. The materials obtained will be referred to in the following as A1 and B1.

Then, the sides coated with the metallised film were coated with the toner-absorbing coating compound and dried. The application quantity of the coating compound was selected such that a dry coating of 0.5 g/m² is created. The compositions of the coating compounds are indicated in the following.

### Coating Compound a

A dispersion of 3.0 of a conductive pigment (antimony-doped titanium tin oxide FT-2000, manufacturer ISK ISHIHARA SANGYO KAISHA Ltd., Japan) was produced in 27 g of water and processed using a rotor-stator mixing system (ULTRA-TURRAX® produced by IKA®, Germany) until the average particle size of the pigment was 180 nm. 22.4 g of ethylene acrylate dispersion MICHEM PRIME® 4990 R.E. was mixed with the dispersion prepared in this way, 0.1 g wetting agent SURFYNOL® 440 and 47.5 g water were further added.

### Coating Compound b

16.3 g ethylene acrylate dispersion MICHEM PRIME® 4990 R.E. was mixed with 29.0 g of a dispersion of AEROSIL® 300 (manufactured by Evonik Degussa AG, Germany) having a solids content of 20% by weight, 3 g of a dispersion of polystyrene sulphonic acid (VERSA® TL 130, manufactured by Akzo Nobel Surface Chemistry AB, Sweden, polymer content 30% by weight, 0.1 g wetting agent SURFYNOL® 440 and 51.6 g water.

### Coating Compound c

19.3 g ethylene acrylate dispersion MICHEM PRIME® 4990 R.E. was mixed with 29.0 g of a dispersion of AEROSIL® 300 (manufactured by Evonik Degussa AG, Germany) having a solids content of 20% by weight, 0.1 g wetting agent SURFYNOL® 440 and 51.6 g water.

### Comparison Examples

The two surfaces of base papers A and B intended to receive printing were irradiated by corona discharge and then laminated with a biaxially oriented polypropylene film TREFAN TND 35 (manufactured by Treofan Germany GmbH & Co. KG). The rear sides of the papers were extrusion coated with a polyethylene mixture as in the examples according to the invention. The materials obtained will be referred to as A2 and B2 in the following.

The two surfaces of papers A2 and B2 intended for printing were then coated with a toner-absorbing coating compound and dried. The applied quantity of the coating composition was chosen so that a dry coating of 0.5 g/m² is obtained. The composition of the coating compound is indicated in the following.

### Coating Compound d (Comparison)

1 g crosslinking agent Surfynol® 440 (available from Air Products, Netherlands) and 72 g water were added to 27.9 g of an ethylene acrylate dispersion MICHEM PRIME® 4990 R.E. (available from Michelman, Belgium) having a polymer content of 35.7% by weight.

The recording materials obtained according to the invention and the comparison samples were subjected to the tests described in the following.

### Surface Resistivity

Measured in accordance with DIN 53483 with a comb electrode, readings measured in log(Ohm/cm)

### Adhesion Test:

Two sheets of the carrier material, size DIN A4, are placed one on top of the other and loaded with a 10 kg weight at 23° C. and 50% RH. After 65 hours the sheets are separated manually and the bond/adhesion is examined.

+: No adhesion,
o: Slight adhesion,
−: Strong adhesion

### Toner Adhesion:

The recording materials are printed using an electrophotographic printer of type HP® Indigo® 6000 and the adhesion of the toner is evaluated at 23° C./50% RH by attaching and detaching a strip of TESA 4104 adhesive tape.

+: Toner layer remains undamaged,
o: Toner layer slightly pulled away,
−: Toner layer pulled away from carrier completely.

### Visual Inspection of the Printing for Shiny Patches:

The recording materials are printed using an electrophotographic printer of type HP® Indigo® 6000 and the print image is examined visually.

+: No shiny patches,
−: Shiny patches evident.

The results of these tests are summarised in the following table 1.

TABLE 1

| Recording | | Surface | Adhesion | Toner | Shiny |
|---|---|---|---|---|---|
| material | | resistivity | test | adhesion | spots |
| A1a | Invention | 7.4 | + | + | + |
| A1b | Invention | 12.0 | + | + | + |
| A1c | Invention | 12.5 | + | + | + |
| B1a | Invention | 7.4 | + | + | + |
| B1b | Invention | 12.0 | + | + | + |
| B1c | Invention | 12.5 | + | + | + |
| A2d | Comparison | >14.9 | ◯ | ◯ | − |
| B2d | Comparison | >14.9 | ◯ | ◯ | − |

In addition, printing tests were carried out with printers IGen® 3 from XEROX® and NeXpress® from Kodak®, which work with dry toners. The following table 2 shows the results of these tests (averages for the 3 printers). Toner transfer to the recording sheet was evaluated visually with reference to uniformity of homogeneously printed colour surfaces, wherein “+” stands for good uniformity, “o” for slight density fluctuations, and “−” stands for significant density fluctuations in the reproduced image.

| Recording | | Toner | Toner | Shiny |
|---|---|---|---|---|
| material | | transfer | adhesion | spots |
| A1a | Invention | + | + | + |
| A1b | Invention | + | + | + |
| A1c | Invention | ◯ | + | + |
| B1a | Invention | + | + | + |
| B1b | Invention | + | + | + |
| B1c | Invention | ◯ | + | + |
| A2d | Comparison | − | ◯ | − |
| B2d | Comparison | − | ◯ | − |

### Evaluation of Results

It was revealed that the images obtained when using the recording materials according to the invention have an appearance comparable to the appearance of silver halide photographs, and comparable haptics. Adhesion of the toner to the surface is good in the recording materials according to the invention, the sheets to not stick together, they do not charge each other electrostatically, and they provide uniform toner transmission when both dry toners and liquid toners are used. Shiny spots caused by dripping of the oils used as auxiliary substances in the toners are avoided definitively.

We claim:

1. Recording material for electrophotographic printing processes, comprising a carrier material and at least one toner-absorbing layer, wherein the recording material contains a plastic film arranged between the carrier material and the toner-absorbing layer, and coated with a metal.

2. The recording material of claim 1, wherein the metal has an electrical conductivity not exceeding 40×106 S/m.

3. The recording material of claim 2, wherein the metal is aluminium.

4. The recording material of claim 3, wherein the plastic film is a multilayer, biaxially oriented polypropylene film.

5. The recording material of claim 4, wherein the metal-coated side of the plastic film has a specific roughness, expressed by the roughness value Rz, from 0.01 to 2 μm.

6. The recording material of claim 1, wherein the rear side of the carrier material has a resin layer.

7. The recording material of claim 6, wherein the resin layer is an extruded polyolefin layer or a polymer film that is laminated on.

8. The recording material of claim 1, wherein the toner-absorbing layer contains a binder that is soluble and/or dispersible in water, a finely particulate inorganic pigment and/or an electrically conductive component.

9. The recording material of claim 8, wherein the binder that is dispersible in water is an ethylene acrylate polymer or an ethylene acrylate copolymer.

10. The recording material of claim 9, wherein the finely particulate inorganic pigment is aluminium oxide, aluminium oxide hydrate, silicic acid, an oxide of antimony, indium, titanium, zinc or tin, or a mixed oxide of two or more of these elements.

11. The recording material of claim 10, wherein the finely particulate inorganic pigment has an average particle size from 10 nm to 2 μm.

12. The recording material of claim 11, wherein the finely particulate inorganic pigment has a BET surface area of 10 m²/g to 400 m²/g.

13. The recording material of claim 8, wherein the electrically conductive component is a finely particulate, electrically conductive pigment.

14. The recording material of claim 8, wherein the conductive component is an electrically conductive polymer.

15. The recording material of claim 8, wherein the quantity of the electrically conductive component in the toner-absorbing layer is from 0 to 50% by weight, particularly 0.1 to 4.0% by weight, relative to the mass of the dried layer.

16. The recording material of claim 1, wherein the carrier material is a base paper or a coated base paper.

17. The recording material of claim 6, wherein the surface resistivity of the recording material is less than 15 (Ohm/cm), measured in accordance with DIN 53483.

18. Recording material for electrophotographic printing processes, comprising a carrier material and at least one toner-absorbing layer, wherein the recording material contains a plastic film arranged between the carrier material and the toner-absorbing layer, and coated with a metal, to provide a metal-coated side, wherein:
a) the metal is aluminium and has an electrical conductivity not exceeding 40×106 S/m,
b) the plastic film is a multilayer, biaxially oriented polypropylene film,
c) the metal-coated side of the plastic film has a specific roughness, expressed by the roughness value Rz, from 0.01 to 2 μm, and
d) the rear side of the carrier material has a resin layer, wherein the resin layer is an extruded polyolefin layer or a polymer film that is laminated on.

19. A recording material of claim 18, wherein:
a) the toner-absorbing layer contains a binder that is soluble and/or dispersible in water, a finely particulate inorganic pigment and/or an electrically conductive component,
b) the binder is an ethylene acrylate polymer or an ethylene acrylate copolymer,
c) the finely particulate inorganic pigment is aluminium oxide, aluminium oxide hydrate, silicic acid, an oxide of antimony, indium, titanium, zinc or tin, or a mixed oxide of two or more of these elements,
d) the finely particulate pigment has an average particle size from 10 nm to 2 μm and a BET surface area of 10 m²/g to 400 m²/g, and
wherein the electrically conductive component is a finely particulate, electrically conductive pigment.

20. A recording material of claim 18, wherein:
a) the toner-absorbing layer contains a binder that is soluble and/or dispersible in water, er, a finely particulate inorganic pigment and/or an electrically conductive component.
b) the binder is an ethylene acrylate polymer or an ethylene acrylate copolymer,
c) the finely particulate inorganic pigment is aluminium oxide, aluminium oxide hydrate, silicic acid, an oxidc of antimony, indium, titanium, zinc or tin, or a mixed oxidc of two or more of these elements, and
d) the finely particulate pigment has an average particle size from 10 nm to 2 μm and a BET surface area of 10 m²/g to 400 m²/g, and
wherein the electrically conductive component is an electrically conductive polymer,
wherein the quantity of the electrically conductive component in the toner-absorbing layer is from 0 to 50% by weight, particularly 0.1 to 4.0% by weight, relative to the mass of the dried layer,
wherein the carrier material is a base paper or a coated base paper, and
wherein the surface resistivity of the recording material is less than 15 (Ohm/cm), measured in accordance with DIN 53483.
